(19) United States
(12) Patent Application Publication
(10) Pub. No.: US 2026/0052568 A1
(43) Pub. Date: Feb. 19, 2026

(54) TXOP SHARING FOR WIRELESS NETWORK

(71) Applicant: TP-Link Systems Inc., Irvine, CA (US)

(72) Inventors: Yunpeng YANG, Shenzhen (CN); Junbin CHEN, Shenzhen (CN)

(73) Assignee: TP-Link Systems Inc., Irvine, CA (US)

(21) Appl. No.: 18/802,946

(22) Filed: Aug. 13, 2024

(51) Int. Cl. H04W 74/0816; H04W 72/04; H04W 72/542; H04W 74/08

(52) U.S. Cl. CPC H04W 74/0816; H04W 72/04; H04W 72/542; H04W 74/0875

(57) ABSTRACT

This disclosure provides a method for transmission opportunity (TXOP) sharing by a sharing access point (AP), a method for TXOP sharing by a shared AP, a sharing AP, a shared AP, a non-transitory computer readable medium and a computer program product. The method includes: transmitting, to at least one candidate shared AP, a first message indicating that a TXOP owned by the sharing AP is sharable; receiving one or more second messages respectively from one or more shared APs of the at least one candidate shared AP, wherein each of the one or more second messages indicates resource requirement information of one of the one or more shared APs; and performing resource allocation for the TXOP to the one or more shared APs based on an available channel resource of the sharing AP and the resource requirement information of the one or more shared APs.

### TECHNICAL FIELD

The present disclosure relates to wireless network technology, and more specifically, to a method for transmission opportunity (TXOP) sharing by a sharing access point (AP), a method for TXOP sharing by a shared AP, a sharing AP, a shared AP, a non-transitory computer readable medium and a computer program product.

### BACKGROUND

With the development of communication technology, wireless local area network (WLAN) technology based on The Institute of Electrical and Electronics Engineers (IEEE) 802.11 standard has been widely used.

Transmission opportunity (TXOP) is a media access control (MAC) layer function used in WLAN based on IEEE 802.11. TXOP defines the time duration that an access point (AP) or a station (STA) can transmit data after contending for a channel resource, and it is a limited time period of contention-free channel access available to the TXOP-owner to transmit data on the channel resource.

### SUMMARY

The present disclosure provides techniques for transmission opportunity (TXOP) sharing.

According to an aspect of the present disclosure, there is provided a method for TXOP sharing by a sharing AP, comprising:
transmitting, to at least one candidate shared AP, a first message indicating that a TXOP owned by the sharing AP is sharable;
receiving one or more second messages respectively from one or more shared APs of the at least one candidate shared AP, wherein each of the one or more second messages indicates resource requirement information of one of the one or more shared APs; and
performing resource allocation for the TXOP to the one or more shared APs based on an available channel resource of the sharing AP and the resource requirement information of the one or more shared APs.

In some embodiments, the performing the resource allocation for the TXOP to the one or more shared APs based on an available channel resource of the sharing AP and the resource requirement information of the one or more shared APs comprises:
determining a first resource allocation result for the TXOP to the one or more shared APs based on the available channel resource of the sharing AP and the resource requirement information of the one or more shared APs.

In some embodiments, the resource requirement information of each one of the one or more shared APs includes an operating channel resource and primary channel information of the one of the one or more shared APs,
wherein the performing resource allocation for the TXOP to the one or more shared APs based on an available channel resource of the sharing AP and the resource requirement information of the one or more shared APs includes:
allocating one or more channels of the available channel resource of the sharing AP to each one of at least one shared AP of the one or more shared APs, the one or more channels being within the operating channel resource of the one of the at least one shared AP and including at least a primary channel indicated by the primary channel information of the one of the at least one shared AP.

In some embodiments, the performing the resource allocation for the TXOP to the one or more shared APs based on an available channel resource of the sharing AP and the resource requirement information of the one or more shared APs further comprises:
transmitting the first resource allocation result to the one or more shared APs, in response to that the available channel resource of the sharing AP covers all operating channel resource(s) of the one or more shared APs.

In some embodiments, the performing the resource allocation for the TXOP based on an available channel resource of the sharing AP and the resource requirement information of the one or more shared APs further comprises:
transmitting the first resource allocation result and a third message including the resource requirement information of the one or more shared APs to a first shared AP of the one or more shared APs to instruct the first shared AP to detect a usable channel resource covering and larger than the available channel resource of the sharing AP in the operating channel resource of the first shared AP for the TXOP and allocate the detected usable channel resource, in response to that the available channel resource of the sharing AP does not cover all operating channel resource(s) of the one or more shared APs and the operating channel resource of the first shared AP covers all of the available channel resource of the sharing AP and the operating channel resource(s) of the one or more shared APs.

In some embodiments, the third message instructs the first shared AP to detect a usable channel resource covering and larger than the available channel resource of the sharing AP in the operating channel resource of the first shared AP for the TXOP and allocate the detected usable channel resource by:
detecting whether there is the usable channel resource;
determining a second resource allocation result for the TXOP to the one or more shared APs based on the detected usable channel resource and the resource requirement information of the one or more shared APs, and transmitting the second resource allocation result to the other shared AP(s) than the first shared AP of the one or more shared APs, in response to that the usable channel resource is detected; and
transmitting the first resource allocation result to the other shared AP(s) than the first shared AP of the one or more shared APs, in response to that the usable channel resource is not detected.

In some embodiments, the performing the resource allocation for the TXOP based on an available channel resource of the sharing AP and the resource requirement information of the one or more shared APs further comprises:
transmitting the first resource allocation result and a fourth message to the one or more shared APs to instruct a second shared AP of the one or more shared APs to detect a usable channel resource covering and lager than a channel resource allocated by the first resource allocation result in the operating channel resource of the second shared AP for the TXOP and perform data transmission on the detected usable channel resource, in response to that the available channel resource of the sharing AP does not cover all operating channel resource(s) of the one or more shared APs and none of operating channel resource(s) of the one or more shared APs covers all of the available channel resource of the sharing AP and the operating channel resource(s) of the one or more shared APs, wherein at least part of the operating channel resource of the second shared AP is uncovered by the available channel resource of the sharing AP.

In some embodiments, the fourth message instructs the second shared AP to detect a usable channel resource covering and lager than the channel resource allocated by the first resource allocation result in the operating channel resource of the second shared AP for the TXOP and perform data transmission on the detected usable channel resource, by:
detecting whether there is the usable channel resource;
transmitting, data on the detected usable operating channel resource in the TXOP, in response to that the usable channel resource is detected; and
transmitting, data on the channel resource allocated by the first resource allocation in the TXOP, in response to that the usable channel resource is not detected.

In some embodiments, the performing the determining a first resource allocation result for the TXOP based on the available channel resource of the sharing AP and the resource requirement information of the one or more shared APs further comprises:
determining, in response to that the primary channel information indicates that primary channels of two or more third shared APs of the one or more shared APs are a same channel, which one of the two or more third shared APs is allocated with the same channel based on priorities of the two or more third shared APs.

In some embodiments, the resource requirement information of the one of the one or more shared APs further includes Quality of Service (QoS) information of the one of the one or more shared APs, and the priorities of the two or more third shared APs are determined based on the QoS information of the two or more third shared APs.

In some embodiments, the priorities of the two or more shared APs are determined further based on a first set of random numbers generated for the two or more third shared APs and/or a second set of random numbers generated for the two or more second third APs in a previous TXOP sharing process.

According to another aspect of the present disclosure, there is provided a method for transmission opportunity (TXOP) sharing by a shared access point (AP), comprising:
receiving, from a sharing AP, a first message indicating that a TXOP owned by the sharing AP is sharable;
transmitting, to the sharing AP, a second message indicating resource requirement information of the shared AP; and
receiving, from the sharing AP, a first resource allocation result determined based on an available channel resource of the sharing AP and the resource requirement information of one or more shared APs including the shared AP.

In some embodiments, the method further comprises:
transmitting data by using a channel resource allocated by the first resource allocation result during the TXOP.

In some embodiments, wherein the method further comprises, in response to receiving, from the sharing AP, a third message including the resource requirement information of the one or more shared APs to instruct the shared AP to detect a usable channel resource covering and larger than the available channel resource of the sharing AP in the operating channel resource of the shared AP for the TXOP and allocate the detected usable channel resource:
detecting whether there is the usable channel resource;
determining a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected; and
transmitting the first resource allocation result to other shared AP(s) of the one or more shared AP(s), in response to that the usable channel resource is not detected.

In some embodiments, the resource requirement information of each one of the one or more shared APs includes an operating channel resource and primary channel information of the one of the one or more shared APs,
wherein the determining a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected comprises:
allocating one or more channels of the detected usable channel resource of the shared AP to each one of at least one shared AP of the one or more shared APs, the one or more channels being within the operating channel resource of the one of the at least one shared AP and including at least a primary channel indicated by the primary channel information of the one of the at least one shared AP.

In some embodiments, the determining, a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected further comprises:
determining, in response to that the primary channel information indicates that primary channels of two or more shared APs of the one or more shared APs are a same channel, which one of the two or more shared APs is allocated with the same channel based on priorities of the two or more shared APs.

In some embodiments, the resource requirement information of each one of one or more shared APs further includes Quality of Service (QoS) information of the one of the one or more shared APs, and the priorities of the two or more third shared APs are determined based on the QoS information of the two or more third shared APs.

In some embodiments, the priorities of the two or more shared APs are determined further based on a first set of random numbers generated for the two or more shared APs and/or a second set of random numbers generated for the two or more shared APs in a previous TXOP sharing process.

In some embodiments, the method further comprises:
in response to receiving, from the sharing AP, a fourth message to instruct the shared AP to detect a usable channel resource covering and lager than the channel resource allocated by the first resource allocation result in the operating channel resource of the shared AP for the TXOP and perform data transmission on the detected usable channel resource:
detecting whether there is the usable channel resource;
transmitting, data on the detected usable operating channel resource in the TXOP, in response to that the usable channel resource is detected; and transmitting data on the channel resource allocated by the first resource allocation
in the TXOP, in response to that the usable channel resource is not detected.

According to yet another aspect of the present disclosure, there is provided a sharing AP for transmission opportunity TXOP sharing, comprising:
one or more processors; and
one or more memories, in which program instructions are stored,
wherein the program instructions, when executed by the one or more processors, perform a method for TXOP sharing, comprising:
transmitting, to at least one candidate shared AP, a first message indicating that a TXOP owned by the sharing AP is sharable;
receiving one or more second messages respectively from one or more shared APs of the at least one candidate shared AP, wherein each of the one or more second messages indicates resource requirement information of one of the one or more shared APs; and
performing resource allocation for the TXOP to the one or more shared APs based on an available channel resource of the sharing AP and the resource requirement information of the one or more shared APs.

In some embodiments, the program instructions, when executed by the one or more processors, perform the resource allocation for the TXOP to the one or more shared APs based on an available channel resource of the sharing AP and the resource requirement information of the one or more shared APs by:
determining a first resource allocation result for the TXOP to the one or more shared APs based on the available channel resource of the sharing AP and the resource requirement information of the one or more shared APs.

In some embodiments, the resource requirement information of each one of the one or more shared APs includes an operating channel resource and primary channel information of the one of the one or more shared APs,
wherein the program instructions, when executed by the one or more processors, perform the determining a first resource allocation result for the TXOP based on the available channel resource of the sharing AP and the resource requirement information of the one or more shared APs by:
allocating one or more channels of the available channel resource of the sharing AP to each one of at least one shared AP of the one or more shared APs, the one or more channels being within the operating channel resource of the one of the at least one shared AP and including at least a primary channel indicated by the primary channel information of the one of the at least one shared AP.

In some embodiments, the program instructions, when executed by the one or more processors, perform the resource allocation for the TXOP to the one or more shared APs based on an available channel resource of the sharing AP and the resource requirement information of the one or more shared APs further by:
transmitting the first resource allocation result to the one or more shared APs, in response to that the available channel resource of the sharing AP covers all operating channel resource(s) of the one or more shared APs.

In some embodiments, the program instructions, when executed by the one or more processors, perform the resource allocation for the TXOP based on an available channel resource of the sharing AP and the resource requirement information of the one or more shared APs further by:
transmitting the first resource allocation result and a third message including the resource requirement information of the one or more shared APs to a first shared AP of the one or more shared APs to instruct the first shared AP to detect a usable channel resource covering and larger than the available channel resource of the sharing AP in the operating channel resource of the first shared AP for the TXOP and allocate the detected usable channel resource, in response to that the available channel resource of the sharing AP does not cover all operating channel resource(s) of the one or more shared APs and the operating channel resource of the first shared AP covers all of the available channel resource of the sharing AP and the operating channel resource(s) of the one or more shared APs.

In some embodiments, the third message instructs the first shared AP to detect a usable channel resource covering and larger than the available channel resource of the sharing AP in the operating channel resource of the first shared AP for the TXOP and allocate the detected usable channel resource by:
detecting whether there is the usable channel resource;
determining a second resource allocation result for the TXOP to the one or more shared APs based on the detected usable channel resource and the resource requirement information of the one or more shared APs, and transmitting the second resource allocation result to the other shared AP(s) than the first shared AP of the one or more shared APs, in response to that the usable channel resource is detected; and
transmitting the first resource allocation result to the other shared AP(s) than the first shared AP of the one or more shared APs, in response to that the usable channel resource is not detected.

In some embodiments, the program instructions, when executed by the one or more processors, perform the resource allocation for the TXOP based on an available channel resource of the sharing AP and the resource requirement information of the one or more shared APs further by:
transmitting the first resource allocation result and a fourth message to the one or more shared APs to instruct a second shared AP of the one or more shared APs to detect a usable channel resource covering and lager than a channel resource allocated by the first resource allocation result in the operating channel resource of the second shared AP for the TXOP and perform data transmission on the detected usable channel resource, in response to that the available channel resource of the sharing AP does not cover all operating channel resource(s) of the one or more shared APs and none of operating channel resource(s) of the one or more shared APs covers all of the available channel resource of the sharing AP and the operating channel resource(s) of the one or more shared APs, wherein at least part of the operating channel resource of the second shared AP is uncovered by the available channel resource of the sharing AP.

In some embodiments, the fourth message instructs the second shared AP to detect a usable channel resource covering and lager than the channel resource allocated by the first resource allocation result in the operating channel resource of the second shared AP for the TXOP and perform data transmission on the detected usable channel resource, by:
detecting whether there is the usable channel resource;
transmitting, data on the detected usable operating channel resource in the TXOP, in response to that the usable channel resource is detected; and
transmitting, data on the channel resource allocated by the first resource allocation in the TXOP, in response to that the usable channel resource is not detected.

In some embodiments, the program instructions, when executed by the one or more processors, perform the determining a first resource allocation result for the TXOP based on the available channel resource of the sharing AP and the resource requirement information of the one or more shared APs further by:
determining, in response to that the primary channel information indicates that primary channels of two or more third shared APs of the one or more shared APs are a same channel, which one of the two or more third shared APs is allocated with the same channel based on priorities of the two or more third shared APs.

In some embodiments, the resource requirement information of each one of the one or more shared APs further includes Quality of Service (QoS) information of the one of the one or more shared APs, and the priorities of the two or more third shared APs are determined based on the QoS information of the two or more third shared APs.

In some embodiments, the priorities of the two or more shared APs are determined further based on a first set of random numbers generated for the two or more third shared APs and/or a second set of random numbers generated for the two or more second third APs in a previous TXOP sharing process.

According to yet another aspect of the present disclosure, there is provided a shared access point (AP), comprising:
one or more processors; and
one or more memories, in which program instructions are stored,
wherein the program instructions, when executed by the one or more processors,
perform a method for transmission opportunity (TXOP) sharing by a shared AP, comprising:
receiving, from a sharing AP, a first message indicating that a TXOP owned by the sharing AP is sharable;
transmitting, to the sharing AP, a second message indicating resource requirement information of the shared AP; and
receiving, from the sharing AP, a first resource allocation result determined based on an available channel resource of the sharing AP and the resource requirement information of one or more shared APs including the shared AP.

In some embodiments, the program instructions, when executed by the one or more processors, further perform:
transmitting data by using a channel resource allocated by the first resource allocation result during the TXOP.

In some embodiments, the program instructions, when executed by the one or more processors, further perform:
in response to receiving, from the sharing AP, a third message including the resource requirement information of the one or more shared APs to instruct the shared AP to detect a usable channel resource covering and larger than the available channel resource of the sharing AP in the operating channel resource of the shared AP for the TXOP and allocate the detected usable channel resource:
detecting whether there is the usable channel resource;
determining a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected; and
transmitting the first resource allocation result to other shared AP(s) of the one or more shared AP(s), in response to that the usable channel resource is not detected.

In some embodiments, the resource requirement information of each one of the one or more shared APs includes an operating channel resource and primary channel information of the one of the one or more shared APs,
wherein the program instructions, when executed by the one or more processors, perform the determining a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected, further by:
allocating one or more channels of the detected usable channel resource of the shared AP to each one of at least one shared AP of the one or more shared APs, the one or more channels being within the operating channel resource of the one of the at least one shared AP and including at least a primary channel indicated by the primary channel information of the one of the at least one shared AP.

In some embodiments, the program instructions, when executed by the one or more processors perform the determining, a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected, further by:
determining, in response to that the primary channel information indicates that primary channels of two or more shared APs of the one or more shared APs are a same channel, which one of the two or more shared APs is allocated with the same channel based on priorities of the two or more shared APs.

In some embodiments, the resource requirement information of each one of one or more shared APs further includes Quality of Service (QoS) information of the one of the one or more shared APs, and the priorities of the two or more third shared APs are determined based on the QoS information of the two or more third shared APs.

In some embodiments, the priorities of the two or more shared APs are determined further based on a first set of random numbers generated for the two or more shared APs and/or a second set of random numbers generated for the two or more shared APs in a previous TXOP sharing process.

In some embodiments, the program instructions, when executed by the one or more processors, further perform: in response to receiving, from the sharing AP, a fourth message to instruct the shared AP to detect a usable channel resource covering and lager than the channel resource allocated by the first resource allocation result in the operating channel resource of the shared AP for the TXOP and perform data transmission on the detected usable channel resource, by:
detecting whether there is the usable channel resource;
transmitting, data on the detected usable operating channel resource in the TXOP, in response to that the usable channel resource is detected; and
transmitting, data on the channel resource allocated by the first resource allocation in the TXOP, in response to that the usable channel resource is not detected.

According to yet another aspect of the present disclosure, there is provided a non-transitory computer-readable storage medium having computer instructions stored thereon, wherein the computer instructions, when executed by a processor, cause the processor to perform the method according to any one of embodiments.

According to yet another aspect of the present disclosure, there is provided a computer program product comprising computer instructions, wherein the computer instructions, when executed by a processor, cause the processor to perform the method according to any one of embodiments.

Thus, according to the embodiments of the present disclosure, by considering the available channel resource of the sharing AP and the resource requirement information of the one or more shared APs, it is possible to make more suitable resource allocation for the shared AP(s), so as to increase channel utilization, increase data transmission quality, and reduce data transmission delay.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements.

FIG. 1 shows a schematic diagram of a scenario in which there is a wireless communication system including a sharing AP, multiple candidate shared APs and non-AP STAs connected to each of the multiple candidate shared APs.

FIG. 2 shows an exemplified flowchart of a method for TXOP sharing by a sharing AP according to at least one embodiments of the present disclosure.

FIG. 3 shows a schematic diagram illustrating message exchange among a sharing AP, a shared AP and non-AP STAs connected to the shared AP.

FIGS. 4A and 4B show an embodiment in which the available channel resource of the sharing AP covers all operating channel resource(s) of the one or more shared APs.

FIGS. 5A and 5B show an embodiment in which the available channel resource of the sharing AP does not cover all operating channel resource(s) of the one or more shared APs and the operating channel resource of a first shared AP of the one or more shared APs covers all of the available channel resource of the sharing AP and the operating channel resources of the one or more shared APs.

FIGS. 6A and 6B show an embodiment in which the available channel resource of the sharing AP does not cover all operating channel resource(s) of the one or more shared APs and none of operating channel resource(s) of the one or more shared APs covers all of the available channel resource of the sharing AP and operating channel resource(s) of the one or more shared APs.

FIG. 7 shows an embodiment in which the primary channels of two shared APs are the same channel.

FIG. 8 shows a flowchart of a method for TXOP sharing by a shared AP according to at least one embodiment of the present disclosure.

FIG. 9 shows an exemplary block diagram illustrating a sharing AP according to at least one embodiment of the present disclosure.

FIG. 10 shows an exemplary block diagram illustrating a shared AP according to at least one embodiment of the present disclosure.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of said word encompasses those ones listed following the said word and their equivalents, without excluding other elements or objects. Words like “connect” or “link” are not limited to physical or mechanical connections, but may include electrical connections, whether direct or indirect.

In addition, technical features involved in different embodiments of the present disclosure described below may be combined with each other as long as no conflicts occur therebetween.

Triggered TXOP sharing (TXS) in 802.11be allows the AP to allocate a part of its obtained transmission opportunity (TXOP) to an associated non-AP extreme high throughput (EHT) station (STA) for transmitting one or more non-trigger-based (TB) physical layer (PHY) protocol data units (PPDU).

It is also studied to allows an access point (AP) that owns the TXOP to share its TXOP with one or more other APs. Such TXOP sharing also needs the TXOP-owner AP to allocate available temporal, frequency, and/or spatial resources for the AP(s) so that the AP(s) can transmit data on the allocated resources. Herein, the AP owning the TXOP for sharing the TXOP is called a sharing AP, the AP which may receive a TXOP sharing message from the TXOP owner is called a candidate shared AP, and the AP which desires to use the TXOP is called a shared AP.

In order for the sharing AP that wins the TXOP to share its TXOP with the shared AP(s), the present disclosure provides at least embodiments of resource allocation schemes for the sharing AP owning a TXOP to allocate resources among the shared AP(s) who request(s) the TXOP, for the shared AP(s) to transmit data.

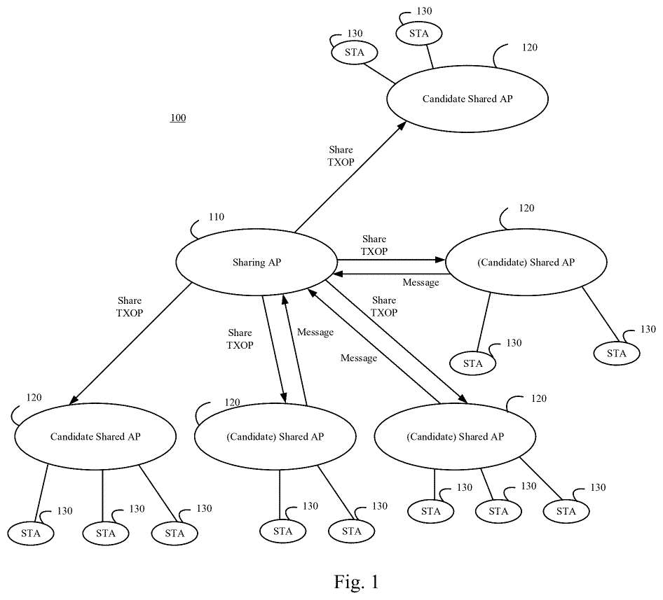

FIG. 1 shows a schematic diagram of a scenario in which there is a wireless communication system 100 including a sharing AP 110, multiple candidate shared APs 120 (in FIG. 1, five candidate shared APs) and non-AP STAs 130 connected to each of the multiple shared APs.

In this scenario, the sharing AP 110 wins a transmission opportunity, i.e., TXOP, and the sharing AP 110 may want to share all or a part of its TXOP with the multiple candidate shared APs 120. The sharing AP 110 may transmit a broadcast message to each of the multiple candidate shared APs 120 to tell the candidate shared AP that the sharing AP has a TXOP to share. One or more shared APs (in FIG. 1, three shared APs) of the multiple candidate shared APs 120 may respond with a message for telling the sharing AP 110 that the shared AP 120 requires the TXOP. The sharing AP 110 may transmit resource allocation to the three shared APs 120, and the three shared APs use a corresponding resource allocated by such resource allocation to transmit data to the STAs 130 during the TXOP, respectively.

In this case, if the sharing AP does not know resource requirement information of the shared AP(s), the sharing AP may not allocate suitable resource to the shared AP(s). and if the sharing AP has a small available resource, and no more channel resource can be utilized, the shared AP(s) may be allocated with a small resource or no resource, and this may result in the poor data transmission or delayed data transmission of the shared AP(s).

The number of the APs in FIG. 1 is only shown for illustration, but not for limitation.

Normally, it is necessary to perform suitable resource allocation to the shared AP(s) so that the shared AP(s) can have a more suitable or larger resource to transmit data, to increase channel utilization, increase data transmission quality, and reduce data transmission delay.

The embodiments of the disclosure allow the shared AP(s) to report its resource requirement information to the sharing AP so that the sharing AP can perform a more suitable resource allocation by considering its own available channel resource and the resource requirement information of the shared AP(s), to allocate more suitable resource to each of the shared AP(s) to transmit data. Since the available channel resource of the sharing AP and operating channel resource(s) of the one or more shared APs may have different bandwidths or include different channels, the present disclosure further provides embodiments to compare the available channel resource of the sharing AP and the operating channel resource(s) of the shared AP(s), and once any one of the shared AP(s) may have a channel resource at least partly larger than the sharing AP's available channel resource, the embodiments allow the sharing AP make the shared AP perform resource allocation on a larger channel resource for itself and/or other shared APs or contend for a larger channel resource before transmitting data, so that the shared AP(s) may have a larger channel resource to transmit data, so as to increase channel utilization, increase data transmission quality, and reduce data transmission delay. The embodiments of the disclosure further provide a conflict solving scheme when the shared APs require the same primary channel, so that the quality of data transmission on the primary channel can be guaranteed.

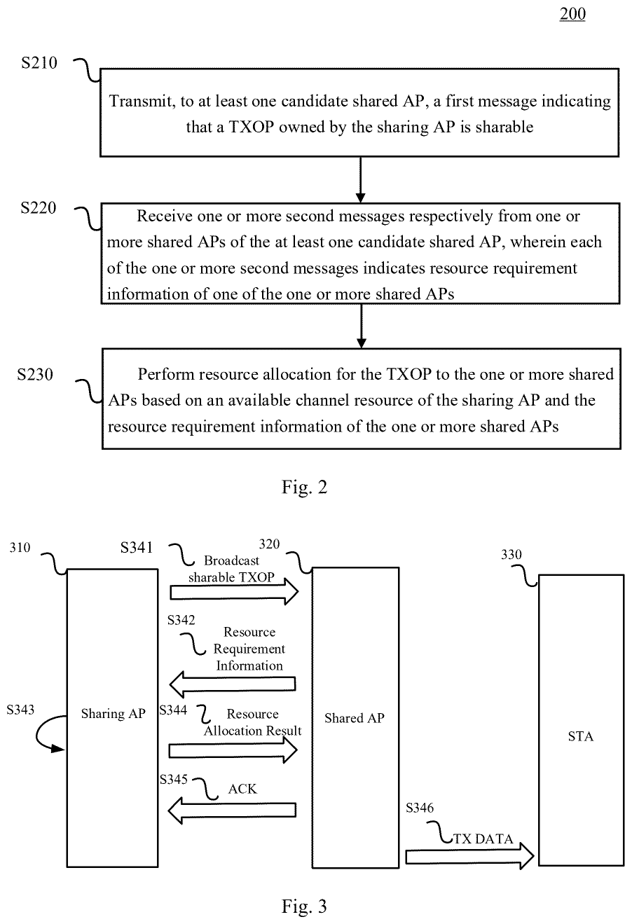

FIG. 2 shows an exemplified flowchart of a method 200 for TXOP sharing by a sharing AP according to at least one embodiments of the present disclosure.

The method 200 includes steps S210, S220 and S230. The steps will be described with reference to FIG. 3 too. FIG. 3 shows a schematic diagram illustrating message exchange among among a sharing AP 310, a shared AP 320 and non-AP STAs 330 connected to the shared AP 320.

Once the sharing AP obtains a TXOP for an available channel resource, it can occupy an available channel resource during the TXOP and transmit data in the TXOP, During the TXOP, other APs are set to be silent or inactive, and cannot initiate new data transmission, but can only receive messages from the sharing AP and provide acknowledge (ACK). The sharing AP may find that it does not need the TXOP to transmit data anymore, for example, after the sharing AP has already finished its desired data transmission during the TXOP, and the sharing AP may desire to share the (rest) sharable TXOP to other APs so that the other APs may transmit data in the sharable TXOP.

At step S210, a first message indicating that a TXOP owned by the sharing AP is sharable is transmitted to at least one candidate shared AP.

The first message may be transmitted in a broadcast frame for broadcasting the first message to the at least one candidate shared AP. Among the at least one candidate shared AP, one or more shared APs may actually require the TXOP to transmit data, and they may transmit one or more second messages to the sharing AP to indicate that they need the TXOP.

For example, with reference to FIG. 3, at step S341, the sharing AP 310 may broadcast a first message indicating that a TXOP owned by the sharing AP is sharable to at least one candidate shared AP (not shown) including the shared AP 320.

Return to FIG. 2, at step S220, the one or more second messages are received by the sharing AP respectively from the one or more shared APs of the at least one candidate shared AP. Each of the one or more second messages may indicate resource requirement information of one of the one or more shared APs. For example, one second message may correspond to resource requirement information of one shared AP. The second message can be also treated as a notification for the shared AP to notify the sharing AP that the shared AP requires the TXOP.

For example, with reference to FIG. 3, the candidate shared AP 320 (which is called the shared AP 320) of the at least one candidate shared AP may require the TXOP, and at step S342, the shared AP 320 may respond to the sharing AP 310 with a second message indicating resource requirement information of the shared AP 310. FIG. 3 only shows one shared AP 320 which requires the TXOP, but FIG. 3 can be applied to other shared AP(s).

The resource requirement information means how the AP requires the channel resource to transmit data. In some embodiments, the resource requirement information of each one of the one or more shared APs may include an operating channel resource and primary channel information of the one of the one or more shared APs.

The operating channel resource of an AP means a maximum channel resource capability including one or more non-overlapped channels at which the AP can operate, so the AP normally requires the whole operating channel resource to transmit data. A channel normally has a 20 MHz bandwidth. For example, the operating channel resource may include one of 20 MHz, 40 MHz, 80 MHZ or 160 MHz, which is not limited herein.

The primary channel information determines a central frequency at which an AP operates. Wireless client devices communicating with the AP can establish initial connection and synchronization on this primary channel. All management frames (such as Beacon frames and Probe response frames) must be transmitted on the primary channel. Control frames may also be usually transmitted on the primary channel. The bandwidth of a primary channel is 20 MHz. The channel(s) other than the primary channel in the operating channel resource can be called as secondary channel(s). In a scenario that an AP uses a wider channel resource (such as 40 MHz, 80 MHz or 160 MHz), the primary channel can be bound with one or more adjacent secondary channels (each of which has a bandwidth of 20 MHz) to form the wider channel resource. Thus, the AP requires at least the primary channel.

In some embodiments, the resource requirement information of each one of the one or more shared APs may further include Quality of Service (QoS) information of the one of the one or more shared APs.

The QoS information may indicate a required service level of data to be transmitted by the shared AP. The higher the QoS level of the data is, the higher the priority of the data is. For example, voice call (VoIP), video conferencing, online games and real-time streaming media, which are very important for delay-sensitive or fixed bandwidth requirements, may be assigned with high QoS levels. In standard 802.11, The QoS information may include normally access category_voice (AC_VO), access category_video (AC_VI), access category_best effort (AC_BE) and access category_Background (AC_BK). AC_VO is for transmitting voice, such as VOIP, AC_VI is for transmitting video, such as video conference, live video steaming and so on. AC_BE is for transmitting relatively low priority normal data, and the AC_BK is for transmitting background data. The priority order is normally that AC_VO>AC_VI>AC_BE>AC_BK.

With reference to FIG. 3, the resource requirement information may include an operating channel resource of the shared AP 310, and primary channel information of the shared AP 310, and optionally QoS information of the shared AP 310.

The detailed utilization of the resource requirement information including one or more of the operating channel resource, the primary channel information, or the QoS information will be described later.

Return to FIG. 2, at step S230, resource allocation for the TXOP to the one or more shared APs is performed based on an available channel resource of the sharing AP and the resource requirement information of the one or more shared APs.

The resource allocation for the TXOP to the one or more shared APs can make each of the one or more shared APs obtain its channel resource to transmit data in the TXOP duration. Performing the resource allocation may include several steps related to the resource allocation, but is not limited to only the step of allocating resource to each of the shared APs. The detailed process of performing the resource allocation will be described later.

The available channel resource of an AP means one or more channels which the AP has contended for, and is usable by the AP to transmit data. The available channel resource of the AP is normally narrower than the operating channel resource of the AP. For example, the operating channel resource of the AP includes 80 MHz, and the available channel resource of the AP may include only 40 MHz.

In some embodiments, the step S230 may include determining a first resource allocation result for the TXOP to the one or more shared APs based on the available channel resource of the sharing AP and the resource requirement information of the one or more shared APs.

The first resource allocation result may indicate exactly which channel or which channels of the available channel resource of the sharing AP are allocated to each of the one or more shared APs. The detailed process of determining the first resource allocation result will be described later.

one or more of the operating channel resource, the primary channel information, or the QoS information may be used in determining a first resource allocation result. In some embodiments, the determining a first resource allocation result may include allocating one or more channels of the available channel resource of the sharing AP to each one of at least one shared AP of the one or more shared APs, the one or more channels being within the operating channel resource of the one of the at least one shared AP and including at least a primary channel indicated by the primary channel information of the one of the at least one shared AP. In some embodiments, the one or more channels of the available channel resource of the sharing AP allocated to one of the one or more shared APs may further include one or more secondary channels in the operating channel resource of the one or more shared APs other than the primary channel. The QoS information may be used for solving conflicts of two or more primary channels required by two or more shared APs, and details will be described later.

For example, with reference to FIG. 3, at step S343, the sharing AP 310 may determine a first resource allocation result to allocate one or more channels of the available channel resource of the sharing AP to the one or more shared APs based on the available channel resource of the sharing AP and the primary channel information and the operating channel resource(s) of the one or more shared APs. In particular, one or more first channels of the available channel resource of the sharing AP may be allocated to a first shared AP, one or more second channels of the available channel resource of the sharing AP may be allocated to a second shared AP, and one or more third channels of the available channel resource of the sharing AP may be allocated to a third shared AP, and so on. Herein, the one or more first channels must cover at least a primary channel indicated by the primary channel information of the first shared AP, and furthermore the one or more first channels may include one or more secondary channels of the operating channel resource of the first shared AP.

After the first resource allocation result is determined, at step S344, the sharing AP 310 may transmit the first resource allocation result to the shared AP 320. The first resource allocation result may also trigger the shared AP 320 to transmit data. Then, at step S345, the shared AP 320 returns an acknowledge (ACK) to indicate that the first resource allocation result is received, and at step S346, the shared AP 320 may use the resource allocated by the first resource allocation result to transmit data to the non-AP STA 330 in the TXOP.

In some embodiments, the first resource allocation result may be transmitted in a multi-user (MU) sharing trigger frame, and the MU sharing trigger frame transmitted to all the shared APs may also include media access control (MAC) addresses of the shared AP(s) and the corresponding allocated channel(s) for each shared AP. The MU sharing trigger frame can activate the silent APs to transmit data in the TXOP. But the disclosure does not limit the form of the first resource allocation result.

Thus, according to the embodiments of the present disclosure, by considering the available channel resource of the sharing AP and the resource requirement information of the one or more shared APs, it is possible to make more suitable resource allocation for shared AP(s), increase channel utilization, increase data transmission quality, and reduce data transmission delay.

Further, since the available channel resource of the sharing AP and operating channel resource(s) of the one or more shared APs may have different bandwidths, the present disclosure further provides embodiments to compare the available channel resource of the sharing AP and the operating channel resource(s) of the shared AP(s), and once any one of the shared AP(s) may have an operating channel resource at least partly larger than the sharing AP's available channel resource, the embodiments allow the sharing AP make the shared AP perform resource allocation on the larger channel resource for itself and/or other APs or contend for a larger channel resource before transmitting data, so that the shared AP(s) may have a larger resource to transmit data, so as to increase channel utilization, increase data transmission quality, and reduce data transmission delay.

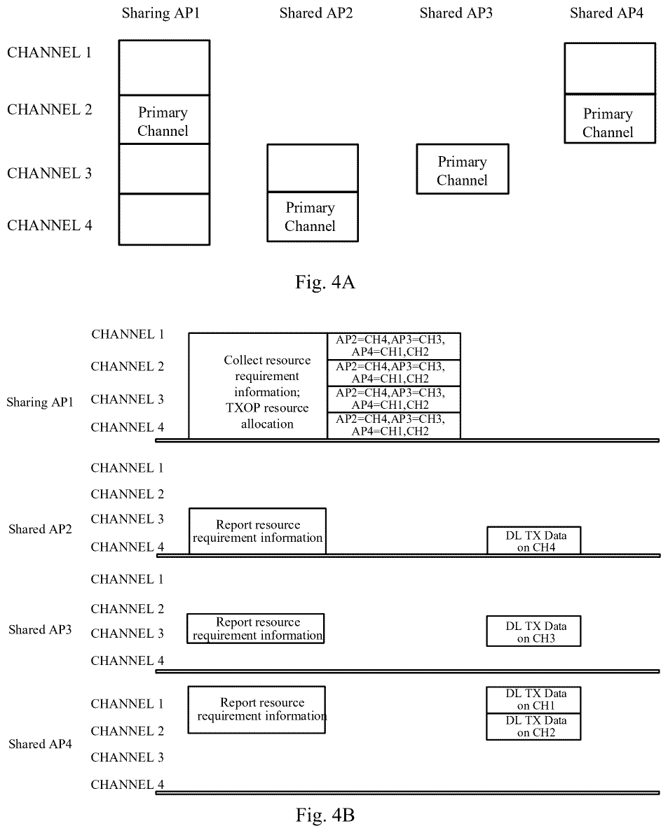

In the embodiments, the available channel resource of the sharing AP may be compared with the operating channel resources of the one or more shared APs to find whether any one of the shared AP(s) has an operating channel resource at least partly larger than the sharing AP's available channel resource. FIGS. 4A, 4B, 5A, 5B, 6A, and 6B show three scenarios by comparing the available channel resource of the sharing AP and the operating channel resources of the one or more shared APs.

In a first scenario, the available channel resource of the sharing AP covers all operating channel resource(s) of the one or more shared APs. Thus, the first resource allocation result determined based on the available channel resource of the sharing AP can make a largest channel resource (i.e., the available channel resource of the sharing AP) be allocated to each of the one or more shared APs. In this case, the first resource allocation result can result in more suitable resource allocation for each of the one or more shared APs. Since the first resource allocation result is already determined based on the largest channel resource, i.e., the available channel resource of the sharing AP, the sharing AP may transmit directly the first resource allocation result to the one or more shared APs, so that the shared AP(s) can obtain a suitable channel resource.

FIGS. 4A and 4B show an example of the first scenario that the available channel resource of the sharing AP covers all operating channel resource(s) of the one or more shared APs.

As shown in FIG. 4A, the available channel resource of the sharing AP, AP1, includes channels, i.e., CHANNEL 1, CHANNEL 2, CHANNEL 3 and CHANNEL 4 bundled together, with the primary channel in CHANNEL 2. It is assumed that each of CHANNEL 1, CHANNEL 2, CHANNEL 3 and CHANNEL 4 has a bandwidth of 20 MHz. The operating channel resource of a shared AP, AP2, requires CHANNEL 3 and CHANNEL 4 bundled together, with the primary channel in CHANNEL 4. The operating channel resource of a shared AP, AP3, requires CHANNEL 3, with the primary channel in CHANNEL 3. The operating channel resource of a shared AP, AP4, requires CHANNEL 1 and CHANNEL 2 bundled together, with the primary channel in CHANNEL 2.

After the comparing, it can be determined that the available channel resource of the sharing AP1 covers all of the operating channel resources of the shared AP2, AP3, and AP4.

Under the scenario of FIG. 4A, as shown in FIG. 4B, after the shared AP2, AP3, and AP4 report their own resource requirement information, the sharing AP1 collects the resource requirement information, and performs TXOP resource allocation. Since the available channel resource of the sharing AP is the largest, the sharing AP1 may allocate one or more channels of the available channel resource of the sharing AP to the shared APs based on the available channel resource of the sharing AP1 and the primary channel information and the operating channel resource(s) of the shared APs. Herein, the allocated one or more channels to a corresponding shared AP are within the operating channel resource of the corresponding shared AP and including at least a primary channel indicated by the primary channel information of the corresponding shared AP. As shown in FIG. 4B, CHANNEL 4 of the available channel resource of the sharing AP1 is allocated to the shared AP2 (AP2=CH4), covering the primary channel of the shared AP2, and CHANNEL 3 of the available channel resource of the sharing AP1 is allocated to the shared AP3 (AP3=CH3), covering the primary channel of the shared AP3. To be noted that secondary channel of the operating channel resource of the shared AP2 requires CHANNEL 3, while the primary channel of the shared AP3 requires CHANNEL 3 too, so CHANNEL 3 is not allocated to the shared AP2, but to the shared AP3, because as mentioned above, the primary channel is necessary for the shared AP, and has a higher priority than the secondary channel(s). For a scenario that the primary channels of two or more shared APs conflict with each other, the disclose further provides a conflict solving scheme for solving this conflict, which will be described later. For the shared AP4, CHANNEL 2 of the available channel resource of the sharing AP1 is allocated to the shared AP4, covering the primary channel of the shared AP4, and since the secondary channel of the operating channel resource of the shared AP4 further requires CHANNEL 1, and no other shared APs requires this channel, so CHANNEL 1 is also allocated to the shared AP4. Thus, CHANNEL 1 and CHANNEL 2 of the available channel resource of the sharing AP1 are allocated to the shared AP4 (AP4=CH1, CH2).

The sharing AP1 transmits the resource allocation result (that is, AP2=CH4, AP3=CH3, and AP4=CH1, CH2) to all the shared AP(s), and the shared AP(s) use(s) its own resource allocated by the resource allocation result to transmit (TX) downlink (DL) data to the STA(s).

Thus, according to the embodiments, by utilizing the available channel resource of the sharing AP which is the largest resource, it is possible to make a more suitable channel resource allocation to the shared AP(s), so that the shared AP(s) may have a larger resource to transmit data, so as to increase channel utilization, increase data transmission quality, and reduce data transmission delay.

In a second scenario, in some embodiments, after the comparing, the available channel resource of the sharing AP may not cover all operating channel resource(s) of the one or more shared APs, but the operating channel resource of the first shared AP of the one or more shared APs may cover all of the available channel resource of the sharing AP and the operating channel resources of the one or more shared APs.

In this case, the step S230 may further include transmitting the first resource allocation result and a third message including the resource requirement information of the one or more shared APs to a first shared AP of the one or more shared APs, to instruct the first shared AP to detect a usable channel resource covering and larger than the available channel resource of the sharing AP in the operating channel resource of the first shared AP for the TXOP and allocate the detected usable channel resource. As such, the right to allocate resources can be transferred from the sharing AP to the first shared AP.

The third message may instruct the first shared AP to detect the usable channel resource. In an embodiment, the detecting process may include detecting whether one or more channels in the operating channel resource of the first shared AP uncovered by the available channel resource of the sharing AP are idle, and detected idle one or more channels and the available channel resource of the sharing AP can be combined as the usable channel resource for resource allocation. In another embodiment, the detecting process may include detecting the whole usable channel resource for the operating channel resource of the first shared AP. Other embodiments are applied too.

As described above, the operating channel resource of the first shared AP can cover all of the available channel resource of the sharing AP and the operating channel resources of the one or more shared APs, and is the largest. If the first shared AP can detect the usable channel resource, using such usable channel resource to perform the resource allocation can obtain a larger channel resource than the available channel resource of the sharing AP for allocating to the shared APs, so as to increase channel utilization, increase data transmission quality, and reduce data transmission delay.

The third message may instruct the first shared AP to determine, in response to that the usable channel resource is detected, a second resource allocation result for the TXOP to the one or more shared APs based on the detected usable channel resource and the resource requirement information, and transmit the second resource allocation result to the other shared AP(s) than the first shared AP of the one or more shared APs. Such second resource allocation result can be determined based on the larger detected usable channel resource, so the shared AP(s) can possibly obtain a larger channel resource, so as to increase channel utilization, increase data transmission quality, and reduce data transmission delay.

The third message may instruct the first shared AP to transmit, in response to that the usable channel resource is not detected, the first resource allocation result to other shared AP(s) of the one or more shared APs. Thus, if no larger channel resource is detected, the first shared AP can use the first resource allocation determined by the sharing AP for itself and for the other shared AP(s).

In some embodiments, the process of detecting whether there is the usable channel resource can be performed through idle channel detection (ICD). The idle channel detection is to detect at least one idle channel which is not occupied by any AP. One example of the idle channel detection is distributed coordination function (DCF). Basically, under DCF mechanism, a device may listen to whether the channel resource is idle before transmitting data. If the channel resource is idle (that is, the usable channel resource is detected), the first shared AP may allocate the usable channel resource, and transmit data on the allocated resource. If the channel resource is occupied (that is, the usable channel resource is not detected), in an embodiment, the shared AP may wait for a random time interval to detect the usable channel resource again, so as to try to obtain a larger channel resource to allocate. In another embodiment, If the channel resource is occupied (that is, the usable channel resource is not detected), the first shared AP may directly utilize the first resource allocation result. However, the disclosure does not limit this, and other idle channel detection schemes can be applied.

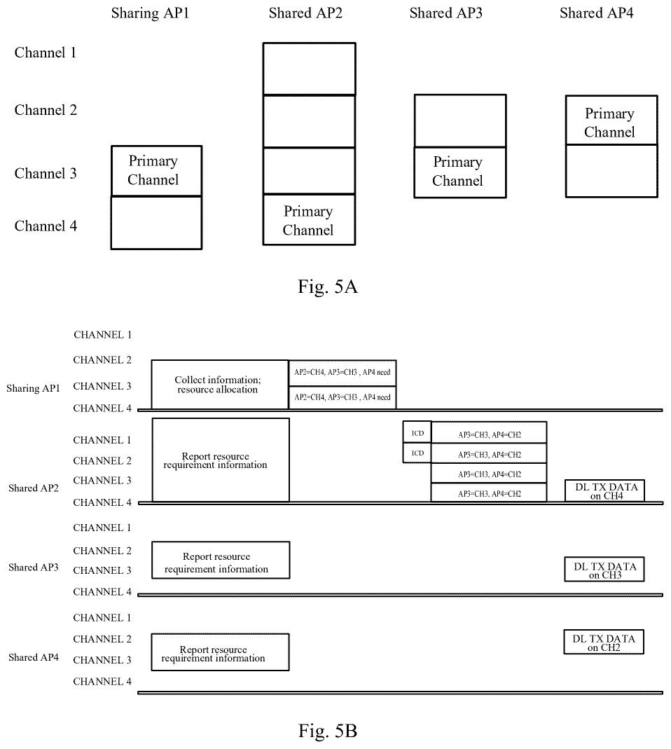

FIGS. 5A and 5B show an example of the second scenario that the available channel resource of the sharing AP does not cover all operating channel resource(s) of the one or more shared APs and the operating channel resource of the first shared AP of the one or more shared APs covers all of the available channel resource of the sharing AP and the operating channel resources of the one or more shared APs.

As shown in FIG. 5A, the available channel resource of the sharing AP1, includes CHANNEL 3 and CHANNEL 4, with the primary channel in CHANNEL 3. The operating channel resource of a shared AP2 requires CHANNEL 1, CHANNEL 2, CHANNEL 3 and CHANNEL 4, with the primary channel in CHANNEL 4. The operating channel resource of a shared AP3 requires CHANNEL 2 and CHANNEL 3, with the primary channel in CHANNEL 3. The operating channel resource of a shared AP4 requires CHANNEL 2 and CHANNEL 3, with the primary channel in CHANNEL 2.

After the comparing, it can be determined that the available channel resource (CHANNEL 3 and CHANNEL 4) of the sharing AP1 does not cover all of the operating channel resources of the shared AP2, AP3, and AP4, and the operating channel resource (i.e., CHANNEL 1, CHANNEL 2, CHANNEL 3 and CHANNEL 4) of the shared AP2 can cover all of the available channel resource of the sharing AP1 and the operating channel resources of the shared APs.

Under the scenario of FIG. 5A, as shown in FIG. 5B, after the shared AP2, AP3, and AP4 report their own resource requirement information, the sharing AP1 collects the resource requirement information, and performs TXOP resource allocation. The sharing AP1 may firstly determine the first resource allocation result, to allocate one or more channels of the available channel resource of the sharing AP to the shared APs based on the available channel resource of the sharing AP1 and the primary channel information and the operating channel resource(s) of the shared APs. Herein the allocated one or more channels to the corresponding shared AP at least should cover the primary channel of the corresponding shared AP, and try to cover one or more secondary channels of the corresponding shared AP. Since the sharing AP1 only has available CHANNEL 3 and CHANNEL 4, the first resource allocation result determined by the sharing AP1 may be that AP2=CH3, and AP3=CH4, and AP4 still needs resource. The sharing AP1 transmits the first resource allocation result and the third message to the shared AP2. The shared AP2 corresponds to the first shared AP as above.

Thus, the shared AP2 can have the right to determine a second resource allocation result for the TXOP. In particular, the shared AP 2 may detect a usable channel resource covering and larger than the available channel resource of the sharing AP in the operating channel resource of the first shared AP for the TXOP and allocate the detected usable channel resource. For example, the shared AP 2 may detect a usable channel resource, of CHANNEL 1, CHANNEL 2, CHANNEL 3 and CHANNEL 4, or of CHANNEL 1, CHANNEL 3 and CHANNEL 4, or of CHANNEL 2, CHANNEL 3 and CHANNEL 4, which are all usable channel resource options of covering and larger than the available channel resource (CHANNEL 3 and CHANNEL 4) of the sharing AP1.

If, for example, a usable channel resource including CHANNEL 1, CHANNEL 2, CHANNEL 3 and CHANNEL 4 are detected, the shared AP2 determines a second resource allocation result for the TXOP based on the CHANNEL 1, CHANNEL 2, CHANNEL 3 and CHANNEL 4.

As shown in FIG. 5B, in the second resource allocation result, CHANNEL 4 is allocated to the shared AP2 (AP2=CH4), covering the primary channel of the shared AP2, and CHANNEL 3 is allocated to the shared AP3 (AP3=CH3), covering the primary channel of the shared AP3, and CHANNEL 2 is allocated to the shared AP4 (AP4=CH2) covering the primary channel of the shared AP4.

The shared AP2 transmits the second resource allocation result (that is, AP2=CH4, AP3=CH3, and AP4=CH2) to all the other shared AP(s), and the shared APs uses their own resource allocated by the resource allocation result to transmit downlink data to the STA(s). In this example, the shared AP4 can further use the CHANNEL 2 which is not included in the available channel resource of the sharing AP1.

Thus, according to the embodiments, by utilizing the operating channel resource of the shared AP which is the largest resource, it is possible to make a more suitable channel resource allocation to the shared AP(s), so that the shared AP(s) may have a larger resource to transmit data, so as to increase channel utilization, increase data transmission quality, and reduce data transmission delay.

In another embodiment, if the usable channel resource is not detected, the shared AP2 may transmit the first resource allocation result (i.e., AP2=CH3, and AP3=CH4) determined by the sharing AP1 to other shared AP(s), so that the shared AP(s) can still use the available channel resource of the sharing AP1 to transmit data.

To be noted that in another embodiment, since the shared AP2, instead of the sharing AP1, is to perform the resource allocation, the sharing AP1 may not firstly determine the first resource allocation result and transmit the first resource allocation result to the shared AP2, but instead, merely notifies the shared AP2 about the available channel resource of the sharing AP1, and the shared AP2 may determine the first resource allocation result by considering the available channel resource of the sharing AP1 if the usable channel resource is not detected.

In a third scenario, in some embodiments, the available channel resource of the sharing AP may not cover all operating channel resource(s) of the one or more shared APs and none of operating channel resource(s) of the one or more shared APs may cover all of the available channel resource of the sharing AP and the operating channel resource(s) of the one or more shared APs. That is, none of the available channel resource of the sharing AP and the operating channel resource(s) of the one or more shared APs can cover all the channel resources, in other words, at least a part of the operating channel resource of the shared AP is not covered by the available channel resource of the sharing AP. In this case, merely using any one of the available channel resource of the sharing AP or the operating channel resource(s) of the shared AP(s) to perform resource allocation is not so proper, and there is no need to transfer the right of resource allocation from the sharing AP to any other shared AP. However, the embodiments of the present disclosure can provide a solution to try to have a larger channel resource to transmit data for the shared AP(s).

In this case, the step S230 may include transmitting the first resource allocation result and a fourth message to the one or more shared APs, to instruct a second shared AP of the one or more shared APs to detect a usable channel resource covering and lager than a channel resource allocated by the first resource allocation result in the operating channel resource of the second shared AP for the TXOP and perform data transmission on the detected usable channel resource.

In some embodiments, the fourth message may instruct the second shared AP to detect the usable channel resource; transmit data on the detected usable operating channel resource in the TXOP, in response to that the usable channel resource is detected; and transmit data on the channel resource allocated by the first resource allocation in the TXOP, in response to that the usable channel resource is not detected.

In some embodiments, the process of detecting whether there is the usable channel resource can be performed through idle channel detection. In particular, if the channel resource is idle (that is, the usable channel resource is detected), the shared AP may transmit data on the usable channel resource. If the channel resource is occupied (that is, the usable channel resource is not detected), the shared AP may wait for a random time interval to detect the usable channel resource again, so as to try to obtain a larger channel resource to transmit data. In another embodiment, If the channel resource is occupied (that is, the usable channel resource is not detected), the shared AP may directly utilize the channel resource allocated by the first resource allocation result. However, the disclosure does not limit this, and other channel contention schemes can be applied.

Thus, according to the embodiments, by detecting the usable operating channel resource before transmitting data, the second shared AP can try to obtain a larger channel resource to transmit data.

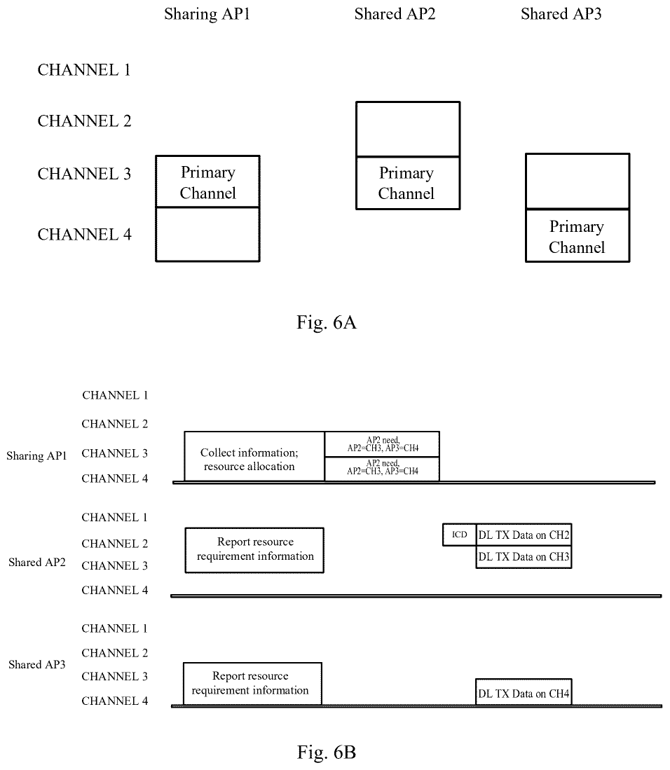

FIGS. 6A and 6B show the third scenario that the available channel resource of the sharing AP does not cover all operating channel resource(s) of the one or more shared APs and none of the operating channel resource(s) of the one or more shared APs covers all of the available channel resource of the sharing AP and operating channel resource(s) of the one or more shared APs.

As shown in FIG. 6A, the available channel resource of the sharing AP1 includes CHANNEL 3 and CHANNEL 4, with the primary channel in CHANNEL 3. The operating channel resource of a shared AP2 requires CHANNEL 2 and CHANNEL 3, with the primary channel in CHANNEL 3. The operating channel resource of a shared AP3 requires CHANNEL 3 and CHANNEL 4, with the primary channel in CHANNEL 4.

After the comparing, it is determined that the available channel resource of the sharing AP1 does not cover all of the operating channel resources of the shared APs and none of operating channel resource(s) of the shared APs covers all of the available channel resource of the sharing AP1 and the operating channel resources of the shared APs. That is, at least a part of the operating channel resource of a shared AP (such as the shared AP2 in FIG. 6A) is uncovered by the available channel resource of the sharing AP1. The shared AP2 may correspond to the second shared AP as above.

Under the scenario of FIG. 6A, as shown in FIG. 6B, after the shared AP2 and AP3 report their own resource requirement information, the sharing AP1 collects the resource requirement information, and performs TXOP resource allocation. The sharing AP1 may firstly determine a first resource allocation result based on the available channel resource of the sharing AP1 and the primary channel information and the operating channel resource(s) of the shared APs. As shown in FIG. 6B, CHANNEL 3 is allocated to the shared AP2 (AP2=CH3), covering the primary channel of the shared AP3, and CHANNEL 4 is allocated to the shared AP3 (AP3=CH4), covering the primary channel of the shared AP4.

Since CHANNEL 2 of the operating channel resource of the shared AP2 is uncovered by the available channel resource of the sharing AP1, the sharing AP1 may transmit the first resource allocation result (i.e., AP2=CH3, AP3=CH4) and a fourth message to the shared AP2 to instruct the shared AP2 to detect a usable channel resource covering and lager than a channel resource allocated by the first resource allocation result in the operating channel resource of the second shared AP for the TXOP and perform data transmission on the detected usable channel resource. The detecting process can be performed by idle channel detection, and details will not be described herein. Since the first resource allocation result does not allocate any channel to the shared AP2 due to small available channel resource of the sharing AP, the share AP2 may try to detect a usable channel resource of CHANNEL 2 and CHANNEL 3,, which are usable channel resource options of covering and lager than a channel resource (CHANNEL 3) allocated by the first resource allocation result. In the embodiment, since CHANNEL 3 is available, it merely needs to detect whether CHANNEL 2 is idle.

If CHANNEL 2 and CHANNEL 3 are detected (i.e., CHANNEL 2 is idle), the shared AP2 may transmit DL data by using the CHANNEL 2 and CHANNEL 3. And if CHANNEL 2 and CHANNEL 3 are not detected (i.e., CHANNEL 2 is not idle), the shared AP2 can use the CHANNEL 3 allocated by the first resource allocation result to transmit data.

Thus, according to the embodiments, even though one or more shared APs are allocated with no or not enough channel resource by the sharing AP1, the one or more shared APs can try to obtain a larger channel resource to transmit data, so as to increase channel utilization, increase data transmission quality, and reduce data transmission delay.

For a scenario that the primary channels of two or more shared APs conflict with each other, the disclose further provides a conflict solving scheme for solving this conflict. Now, the conflict solving scheme is described below.

For example, primary channels of two or more third shared APs of the one or more shared APs may be in a same channel, which means that the primary channels of two or more shared APs conflict with each other. In some embodiments, it may be determined which one of the two or more third shared APs is allocated with the same channel based on priorities of the two or more third shared APs.

In some embodiments, the resource requirement information may further include Quality of Service (QoS) information of each of the one or more shared APs, and the priorities of the two or more third shared APs may be determined based on the QoS information of the two or more third shared APs. In some embodiments, if the QoS information of a third shared AP is the highest, such third shared AP is allocated with the same channel. Thus, it is possible to guarantee the highest-priority data transmission.

In some embodiments, the priorities of the two or more shared APs may be further determined further based on a first set of random numbers generated for the two or more third shared APs and/or a second set of random numbers generated for the two or more second third APs in a previous TXOP sharing process.

Other embodiments of priorities can also be applied. To be noted that the resource allocation for primary channels based on the priorities can also be applied to the resource allocation for one or more secondary channels of the operating channel resource.

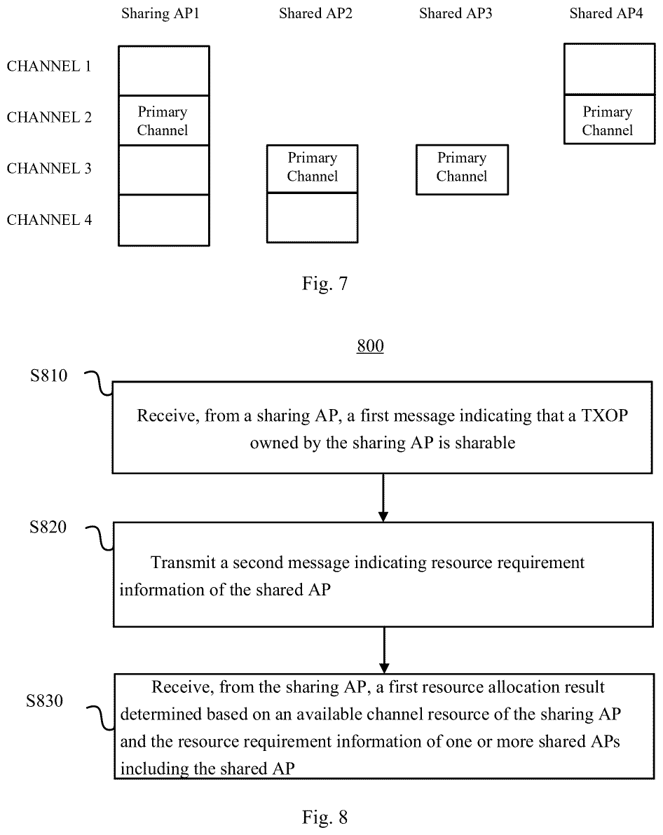

FIG. 7 shows an example of the scenario that the primary channels of two shared APs are in the same channel.

As shown in FIG. 7, the primary channel of the shared AP2 is CHANNEL 3, and the primary channel of the shared AP3 is CHANNEL 3 too. The primary channels are conflict, and a conflict solving scheme can be applied when allocating CHANNEL 3.

In the conflict solving scheme provided by the embodiments of the present disclosure, priorities for the shared AP2 and the shared AP3 may be used to allocate the CHANNEL 3 to the AP with the highest priority. In some embodiments, the priorities may be determined based on the QoS information of the two shared APs, herein the QoS information may indicate different importance of the data transmission, and different priorities may be designated based on the different importance.

For example, the priorities of the shared AP2 and AP3 are labelled as P2 and P3, and are initially designated as 0.

For example, the QoS information of the shared AP2 is AC_VO, and the priority is increased by 4, and the QoS information of the shared AP3 is AC_VI, the priority is increased by 3. In this example, P2=4, and P3=3, so CHANNEL 3 may be allocated to the shared AP2 for guaranteeing transmission of AC_VO data. Thus, by considering QoS information, higher priority data transmission can be guaranteed with the allocated channel resource.

If the QoS information of both the shared AP2 and the shared AP3 is AC_VO, the conflict solving scheme may further include generating a random number for each of the shared AP2 and the shared AP3, for example, 3 is generated for the shared AP2, and 5 is generated for the shared AP3. An example rule may be that the AP with the lowest random number, i.e., the shared AP2, can be allocated with CHANNEL 3. Of course, other rules can be applied. If previous random numbers, for example, 1 and 4 have been generated for the shared AP2 and the shared AP3, and the AP3 with 4 has not been allocated with a channel in the previous TXOP sharing process, then a difference between the 1 and 4 can be recorded as 3, and the random number, i.e., 5, of the shared AP3, which has not obtained the channel previously, minus 3 (equal to 2) as the adjusted random number can be compared with the random number, i.e., 3, of the shared AP2, so the AP3 with the lowest random number, i.e., 2, can be allocated with the available channel in this TXOP sharing process. Thus, by generating the random numbers and adjusting the random numbers based on random numbers generated in the previous TXOP sharing process, it is possible to increase fairness of the resource allocation, and avoid some AP never or seldom obtaining the channel in several TXOP sharing processes.

In some embodiments, the QoS information and the random numbers can be combined as the priority, for example, by adding the QoS level and the random number or else together. Other parameters about priority can also be used. Other conflict solving schemes can be applied to solve such conflicting cases, which are not described herein for simplicity.

To be noted that in the conflict solving scheme, some shared AP(s) (unallocated shared AP(s)) may not be allocated with a channel resource to transmit data, and may be still in the silent state, so how to transmit the resource allocation result is discussed. In an embodiment, the sharing AP may transmit the first resource allocation result or the shared AP may transmit the second resource allocation result to all the shared AP(s) including the unallocated shared AP(s), by designating the MAC addresses of the shared AP(s) and its corresponding allocated channel(s), and the unallocated shared AP(s), after receiving the first/second resource allocation result, determines no MAC address is for it/them, the unallocated shared AP(s) can still be in the silent state. Thus, by transmitting the same first/second resource allocation result, it is possible to reduce complexity of transmission of the first/second resource allocation result. In another embodiment, the sharing AP may transmit respective first/second resource allocation results to only the shared AP(s) which obtain(s) the allocated channel resource, and each first/second resource allocation result may correspond to a MAC address for the specific shared AP to activate it to transmit data, and the unallocated shared AP(s) can still be in the silent state. Thus, by specifying each first/second resource allocation result to the corresponding shared AP, it is possible to reduce the data amount of the first/second resource allocation result transmission. Other embodiments for transmitting the first/second resource allocation result may be applied, and details are omitted for simplicity.

Thus, according to embodiments of the present disclosure, by considering the priorities, it is possible to solve the conflicts of the primary channels of the two or more shared APs, and make more suitable resource allocation for the shared APs, so that the quality of data transmission on the resource can be guaranteed.

FIG. 8 shows a flowchart of a method 800 for TXOP sharing by a shared AP according to at least one embodiment of the present disclosure.

As shown in FIG. 8, the method 800 includes steps S810, S820 and S830.

At step S810, a first message indicating that a TXOP owned by the sharing AP is sharable is received from a sharing AP.

At step S820, a second message indicating resource requirement information of the shared AP is transmitted to the sharing AP.

At step S820, a first resource allocation result determined based on an available channel resource of the sharing AP and the resource requirement information of one or more shared APs including the shared AP is received, from the sharing AP.

Thus, according to the embodiments, the shared AP can obtain more suitable channel resource, increase the channel utilization, increase data transmission quality, and reduce data transmission delay.

In some embodiments, the method 800 further includes transmitting data by using a channel resource allocated by the first resource allocation result during the TXOP. The embodiments are like in the first scenario as above.

In some embodiments, the resource requirement information of each one of one or more shared APs may include an operating channel resource and primary channel information of the one of the one or more shared APs. In response to receiving, from the sharing AP, a third message including resource requirement information of one or more shared APs including the shared AP to instruct the shared AP to detect a usable channel resource covering and larger than the available channel resource of the sharing AP in the operating channel resource of the first shared AP for the TXOP, the method 800 may further include: detecting whether there is the usable channel resource; determining, in response to that the usable channel resource is detected, a second resource allocation result for the TXOP to the one or more shared APs based on the detected usable channel resource, the operating channel resource of the one of the one or more shared APs, and the primary channel information of each of the one or more shared APs, and transmitting the second resource allocation result to other shared AP(s) of the one or more other shared AP(s); and transmitting, in response to that the usable channel resource is not detected, the first resource allocation result to other shared AP(s) of the one or more shared APs. The embodiments are like in the second scenario as above.

Thus, by detecting the usable channel resource, the shared AP can try to obtain a larger channel resource for allocating to the other shared AP(s), so as to increase channel utilization, increase data transmission quality, and reduce data transmission delay.

In some embodiments, the determining, in response to that the usable channel resource is detected, a second resource allocation result for the TXOP to the one or more shared APs based on the detected usable channel resource, the operating channel resource of the one of the one or more shared APs, and the primary channel information of each of the one or more shared APs includes: allocating one or more channels of the available channel resource of the sharing AP to each one of at least one shared AP of the one or more shared APs, the one or more channels being within the operating channel resource of the one of the at least one shared AP and including at least a primary channel indicated by the primary channel information of the one of the at least one shared AP.

In some embodiments, the determining the second resource allocation result further includes: determining, in response to that the primary channel information indicates that primary channels of two or more shared APs of the one or more shared APs are a same channel, which one of the two or more shared APs is allocated with the same channel, based on priorities of the two or more shared APs.

Thus, by considering QoS information, higher priority data transmission can be guaranteed with the allocated channel resource.

In some embodiments, the resource requirement information of each one of one or more shared APs further includes QoS information of the one of the one or more shared APs, and the priorities of the two or more third shared APs are determined based on the QoS information of the two or more third shared APs. The determining a second resource allocation result may further include: determining, in response to that the primary channel information indicates that primary channels of two or more shared APs of the one or more shared APs are a same channel, which one of the two or more shared APs is allocated with the same channel, based on QoS information of the two or more shared APs.

In some embodiments, the priorities of the two or more shared APs are determined further based on a first set of random numbers generated for the two or more shared APs and/or a second set of random numbers generated for the two or more shared APs in a previous TXOP sharing process.

Thus, by generating the random numbers and adjusting the random numbers based on random numbers generated in the previous TXOP sharing process, it is possible to increase fairness of the resource allocation, and avoid some AP never or seldom obtaining the channel.

Thus, according to embodiments of the present disclosure, by considering the priorities, it is possible to solve the conflicts of the primary channels of the two or more shared APs, and make more suitable resource allocation for the shared APs, so that the quality of data transmission on the resource can be guaranteed.

In some embodiments, the method 800 may further include: in response to receiving, from the sharing AP, a fourth message to instruct the shared AP to detect a usable channel resource covering and lager than the channel resource allocated by the first resource allocation result in the operating channel resource of the second shared AP for the TXOP and perform data transmission on the detected usable channel resource: detecting whether there is the usable channel resource; transmitting, data on the detected usable operating channel resource in the TXOP, in response to that the usable channel resource is detected; and transmitting, data on the channel resource allocated by the first resource allocation in the TXOP, in response to that the usable channel resource is not detected. The embodiments are like in the third scenario as above.

Thus, according to the embodiments, even though one or more shared APs are allocated with no or not enough channel resource by the sharing AP1, the one or more shared APs can try to obtain a larger channel resource to transmit data, so as to increase channel utilization, increase data transmission quality, and reduce data transmission delay.

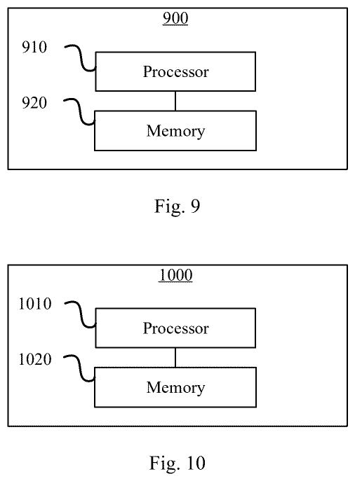

FIG. 9 shows an exemplary block diagram illustrating a sharing AP 900 according to at least one embodiment of the present disclosure.

As shown in FIG. 9, the sharing AP 900 may include one or more processors 910 and a memory 920. The memory 910 is coupled to one or more of the processors 910.

Examples of the one or more processors 910 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality of the control method described throughout this disclosure.

The one or more processors 910 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, such as a set of computer program instructions, may be stored in the memory 920, and when executed by one or more of the processors 910, perform operations of the method according to at least one embodiment of the disclosure. The program instructions, when executed by the one or more processors 910, performs a method for TXOP sharing, including: transmitting, to at least one candidate shared AP, a first message indicating that a TXOP owned by the sharing AP is sharable; receiving one or more second messages respectively from one or more shared APs of the at least one candidate shared AP, wherein each of the one or more second messages indicates resource requirement information of one of the one or more shared APs; and performing resource allocation for the TXOP to the one or more shared APs based on an available channel resource of the sharing AP and the resource requirement information of the one or more shared APs. Other details for the method for TXOP sharing by a sharing AP can be found in the above description, and will be omitted herein.

The memory 920 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 920 may reside in the one or more processors 910, external to the one or more processors 910, or distributed across multiple entities including the one or more processors 910. The memory 920 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

FIG. 10 shows an exemplary block diagram illustrating a shared AP 1000 according to at least one embodiment of the present disclosure.

The shared AP 1000 includes one or more processors 1010; and one or more memories 1020, in which program instructions are stored. The program instructions, when executed by the one or more processors, perform a method for TXOP sharing, including receiving, from a sharing AP, a first message indicating that a TXOP owned by the sharing AP is sharable; transmitting, to the sharing AP, a second message indicating resource requirement information of the shared AP; and receiving, from the sharing AP, a first resource allocation result determined based on an available channel resource of the sharing AP and the resource requirement information of one or more shared APs including the shared AP.

Other details for the method for TXOP sharing by a shared AP can be found in the above description, and will be omitted herein.

It is also disclosed a computer program product according to at least one embodiment of the present disclosure. As an example, the computer program product comprises a non-transitory computer readable storage medium having program instructions embodied therewith, and the program instructions are executable by a processor of an apparatus in or outside an AP in a WLAN. When executed, the program instructions cause the processor to perform one or more of the described operations of methods above, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Expression such as “according to”, “based on”, “dependent on”, and so on as used in the disclosure does not mean “according only to”, “based only on”, or “dependent only on”, unless it is explicitly otherwise stated. In other words, such expression generally means “according at least to”, “based at least on”, or “dependent at least on” in the disclosure.

Any reference in the disclosure to an element using the designation “first”, “second” and so forth is not intended to comprehensively limit the number or order of such elements. These expressions can be used in the disclosure as a convenient method for distinguishing two or more units. Thus, a reference to a first unit and a second unit does not imply that only two units can be employed or that the first unit must precede the second unit in some form.

The term “determining” used in the disclosure can include various operations. For example, regarding “determining”, calculating, computing, processing, deriving, investigating, looking up (e.g., looking up in tables, databases, or other data structure), ascertaining, and so forth are regarded as “determination”. In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth can also be regarded as “determining”. That is, regarding “determining”, several actions can be regarded as “determining”.

The terms such as “connected”, “coupled” or any of their variants used in the disclosure refer to any connection or combination, direct or indirect, between two or more units, which can include the following situations: between two units that are “connected” or “coupled” with each other, there are one or more intermediate units. The coupling or connection between the units can be physical or logical, or can also be a combination of the two. As used in the disclosure, two units can be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure can be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method for TXOP sharing by a sharing AP, comprising:
transmitting, to at least one candidate shared AP, a first message indicating that a TXOP owned by the sharing AP is sharable;
receiving one or more second messages respectively from one or more shared APs of the at least one candidate shared AP, wherein each of the one or more second messages indicates resource requirement information of one of the one or more shared APs; and
performing resource allocation for the TXOP to the one or more shared APs based on an available channel resource of the sharing AP and the resource requirement information of the one or more shared APs.

2. The method of claim 1, wherein the performing the resource allocation for the TXOP to the one or more shared APs based on an available channel resource of the sharing AP and the resource requirement information of the one or more shared APs comprises:
determining a first resource allocation result for the TXOP to the one or more shared APs based on the available channel resource of the sharing AP and the resource requirement information of the one or more shared APs.

3. The method of claim 2, wherein the resource requirement information of each one of the one or more shared APs includes an operating channel resource and primary channel information of the one of the one or more shared APs,
wherein the performing the determining a first resource allocation result for the TXOP to the one or more shared APs based on the available channel resource of the sharing AP and the resource requirement information of the one or more shared APs comprises:
allocating one or more channels of the available channel resource of the sharing AP to each one of at least one shared AP of the one or more shared APs, the one or more channels being within the operating channel resource of the one of the at least one shared AP and including at least a primary channel indicated by the primary channel information of the one of the at least one shared AP.

4. The method of claim 3, wherein the performing the resource allocation for the TXOP to the one or more shared APs based on an available channel resource of the sharing AP and the resource requirement information of the one or more shared APs further comprises:
transmitting the first resource allocation result to the one or more shared APs, in response to that the available channel resource of the sharing AP covers all operating channel resource(s) of the one or more shared APs.

5. The method of claim 3, wherein the performing the resource allocation for the TXOP based on an available channel resource of the sharing AP and the resource requirement information of the one or more shared APs further comprises:
transmitting the first resource allocation result and a third message including the resource requirement information of the one or more shared APs to a first shared AP of the one or more shared APs to instruct the first shared AP to detect a usable channel resource covering and larger than the available channel resource of the sharing AP in the operating channel resource of the first shared AP for the TXOP and allocate the detected usable channel resource, in response to that the available channel resource of the sharing AP does not cover all operating channel resource(s) of the one or more shared APs and the operating channel resource of the first shared AP covers all of the available channel resource of the sharing AP and the operating channel resource(s) of the one or more shared APs.

6. The method of claim 5, wherein the third message instructs the first shared AP to detect a usable channel resource covering and larger than the available channel resource of the sharing AP in the operating channel resource of the first shared AP for the TXOP and allocate the detected usable channel resource by:
detecting whether there is the usable channel resource;
determining a second resource allocation result for the TXOP to the one or more shared APs based on the detected usable channel resource and the resource requirement information of the one or more shared APs, and transmitting the second resource allocation result to the other shared AP(s) than the first shared AP of the one or more shared APs, in response to that the usable channel resource is detected; and
transmitting the first resource allocation result to the other shared AP(s) than the first shared AP of the one or more shared APs, in response to that the usable channel resource is not detected.

7. The method of claim 3, wherein the performing the resource allocation for the TXOP based on an available channel resource of the sharing AP and the resource requirement information of the one or more shared APs further comprises:
transmitting the first resource allocation result and a fourth message to the one or more shared APs to instruct a second shared AP of the one or more shared APs to detect a usable channel resource covering and lager than a channel resource allocated by the first resource allocation result in the operating channel resource of the second shared AP for the TXOP and perform data transmission on the detected usable channel resource, in response to that the available channel resource of the sharing AP does not cover all operating channel resource(s) of the one or more shared APs and none of operating channel resource(s) of the one or more shared APs covers all of the available channel resource of the sharing AP and the operating channel resource(s) of the one or more shared APs, wherein at least part of the operating channel resource of the second shared AP is uncovered by the available channel resource of the sharing AP.

8. The method of claim 7, wherein the fourth message instructs the second shared AP to detect a usable channel resource covering and lager than the channel resource allocated by the first resource allocation result in the operating channel resource of the second shared AP for the TXOP and perform data transmission on the detected usable channel resource, by:
detecting whether there is the usable channel resource;
transmitting data on the detected usable channel resource in the TXOP in response to that the usable channel resource is detected, and
transmitting data on the channel resource allocated by the first resource allocation in the TXOP, in response to that the usable channel resource is not detected.

9. The method of claim 3, wherein the performing the determining a first resource allocation result for the TXOP based on the available channel resource of the sharing AP and the resource requirement information of the one or more shared APs further comprises:
determining, in response to that the primary channel information indicates that primary channels of two or more third shared APs of the one or more shared APs are a same channel, which one of the two or more third shared APs is allocated with the same channel based on priorities of the two or more third shared APs.

10. The method of claim 9, wherein the resource requirement information of each one of the one or more shared APs further includes Quality of Service (QoS) information of the one of the one or more shared APs, and the priorities of the two or more third shared APs are determined based on the QoS information of the two or more third shared APs.

11. A method for transmission opportunity (TXOP) sharing by a shared access point (AP), comprising:
receiving, from a sharing AP, a first message indicating that a TXOP owned by the sharing AP is sharable;
transmitting, to the sharing AP, a second message indicating resource requirement information of the shared AP; and
receiving, from the sharing AP, a first resource allocation result determined based on an available channel resource of the sharing AP and the resource requirement information of one or more shared APs including the shared AP.

12. The method of claim 11, further comprising:
transmitting data by using a channel resource allocated by the first resource allocation result during the TXOP.

13. The method of claim 11, further comprising:
in response to receiving, from the sharing AP, a third message including the resource requirement information of the one or more shared APs to instruct the shared AP to detect a usable channel resource covering and larger than the available channel resource of the sharing AP in the operating channel resource of the shared AP for the TXOP and allocate the detected usable channel resource:
detecting whether there is the usable channel resource;
determining a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected; and
transmitting the first resource allocation result to other shared AP(s) of the one or more shared AP(s), in response to that the usable channel resource is not detected.

14. The method of claim 13, wherein the resource requirement information of each one of the one or more shared APs includes an operating channel resource and primary channel information of the one of the one or more shared APs;
wherein the determining a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected, further comprises:
allocating one or more channels of the detected usable channel resource of the shared AP to each one of at least one shared AP of the one or more shared APs, the one or more channels being within the operating channel resource of the one of the at least one shared AP and including at least a primary channel indicated by the primary channel information of the one of the at least one shared AP.

15. The method of claim 14, wherein the determining, a second resource allocation result for the TXOP to the one or more shared APs based on the detected usable channel resource and the resource requirement information of the one or more shared APs, and transmitting the second resource allocation result to other shared AP(s) of the one or more shared APs, in response to that the usable channel resource is detected, further comprises:
determining, in response to that the primary channel information indicates that primary channels of two or more shared APs of the one or more shared APs are a same channel, which one of the two or more shared APs is allocated with the same channel based on priorities of the two or more shared APs.

16. The method of claim 15, wherein the resource requirement information of each one of one or more shared APs further includes Quality of Service (QoS) information of the one of the one or more shared APs, and the priorities of the two or more third shared APs are determined based on the QoS information of the two or more third shared APs.

17. The method of claim 11, further comprising:
in response to receiving, from the sharing AP, a fourth message to instruct the shared AP to detect a usable channel resource covering and lager than the channel resource allocated by the first resource allocation result in the operating channel resource of the shared AP for the TXOP and perform data transmission on the detected usable channel resource:
detecting whether there is the usable channel resource;
transmitting data on the detected usable operating channel resource in the TXOP, in response to that the usable channel resource is detected; and
transmitting data on the channel resource allocated by the first resource allocation in the TXOP, in response to that the usable channel resource is not detected.

18. A sharing access point (AP) for transmission opportunity (TXOP) sharing, comprising:
one or more processors; and
one or more memories, in which program instructions are stored,
wherein the program instructions, when executed by the one or more processors, perform a method for TXOP sharing, comprising:
transmitting, to at least one candidate shared AP, a first message indicating that a TXOP owned by the sharing AP is sharable;
receiving one or more second messages respectively from one or more shared APs of the at least one candidate shared AP, wherein each of the one or more second messages indicates resource requirement information of one of the one or more shared APs; and
performing resource allocation for the TXOP to the one or more shared APs based on an available channel resource of the sharing AP and the resource requirement information of the one or more shared APs.

19. The sharing AP of claim 18, wherein the program instructions, when executed by the one or more processors, perform the resource allocation for the TXOP to the one or more shared APs based on an available channel resource of the sharing AP and the resource requirement information of the one or more shared APs by:
determining a first resource allocation result for the TXOP to the one or more shared APs based on the available channel resource of the sharing AP and the resource requirement information of the one or more shared APs.

20. The sharing AP of claim 19, wherein the resource requirement information of each one of the one or more shared APs includes an operating channel resource and primary channel information of the one of the one or more shared APs,
wherein the program instructions, when executed by the one or more processors, perform the determining a first resource allocation result for the TXOP based on the available channel resource of the sharing AP and the resource requirement information of the one or more shared APs by:
allocating one or more channels of the available channel resource of the sharing AP to each one of at least one shared AP of the one or more shared APs, the one or more channels being within the operating channel resource of the one of the at least one shared AP and including at least a primary channel indicated by the primary channel information of the one of the at least one shared AP.
